(19) United States
(12) Patent Application Publication
(10) Pub. No.: US 2026/0188106 A1
(43) Pub. Date: Jul. 2, 2026

(54) ALIGNMENT OF DETECTOR DEVICES USING A PROJECTED LIGHT PATTERN

(71) Applicant: MSA TECHNOLOGY, LLC, Cranberry Township, PA (US)

(72) Inventors: Scott Reed, Rancho Santa Margarita, CA (US); David Gherardi, Broadstone (GB)

(21) Appl. No.: 19/005,155

(22) Filed: Dec. 30, 2024

(51) Int. Cl. G08B 29/24; G08B 17/12

(52) U.S. Cl. CPC G08B 29/24; G08B 17/12

(57) ABSTRACT

An alignment device for use with a flame detector having a field of view includes a body, a visualization system in connection with the body and including a light source positioned at a fixed position relative to the body, and an optics system including one or more optical elements which interact with a beam of light from the light source to project a pattern of light indicative of an area of the field of view of the flame detector for a determined distance from the flame detector. The indicated area of the field of view is larger than an area of a projection of the beam of light from the light source. The alignment device further includes a connector in connection with the body to place the alignment device in removable connection with the flame detector.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Flame detector devices or flame detectors are used in many environments. Such flame detectors are often used in hazardous locations such as refineries, chemical plants, compressor stations, and fuel loading facilities. Flame detectors have an optical field of view (sometime referred to simply as a field of view or FOV), within which the detector has sensitivity to detect flames within range of the detector.

Individual flame detectors may, for example, be combined in use to form a network in which each flame detector is positioned in a configuration to cover a larger area. Such a network of flame detectors may be used as part of a detection system which, in turn, may be part of a fire suppression and/or alarm system. Flame detector coverage is important because it contributes to the effectiveness of the system to fight a fire and to warn of the danger.

An individual flame detector may be unable to detect an incipient fire because its optical field of view is blocked by an obstruction larger than the fire, or because the incipient fire is at the periphery of the flame detector's optical field of view (where the detector's sensitivity is typically at its lowest) or outside of the flame detector's field of view or FOV. If detection fails, a flame detection system incorporating the flame detector will not react with the planned fire mitigation action. In such a case, the flame detection system may be considered as having diminished effectiveness as a result of poor detection coverage.

The flame detection system may eventually react at a later stage when the incipient fire has grown in size and falls more squarely within optical field of view of a flame detector. Such a delay in response is clearly undesirable because of the consequences associated with a larger fire and increased fire duration. It is thus very desirable that any fire breakout be detected as early as possible so that, for example, fire mitigation action can be triggered at an earlier stage.

During the installation or commissioning of a flame detector, a user will wish to identify, for example, where the center and at least the outer boundary of the FOV are located in the area to be monitored. A number of alignment aids are currently available for use with flame detectors. Such alignment aids typically employ a laser in a holder that projects a laser dot. A laser source of such devices can be positioned on an axis with the flame detector or at various angles thereto. A laser holder of such devices may also enable movement of the laser source over a range of angles or positions. Movement of the holder may, for example, allow sweeping of a series of individual positions of the laser over time such that serially projected dots of the laser follow the shape of a circle that approximates the outer boundary of the FOV.

### SUMMARY

An alignment device for use with a flame detector having a field of view includes a body and a visualization system in connection with the body. The visualization system include a light source positioned at a fixed position relative to the body and an optics system including one or more optical elements which interact with a beam of light from the light source to project a pattern of light indicative of an area of the field of view of the flame detector for a determined distance from the flame detector. The indicated area (or the area indicated by the projected pattern) of the field of view is larger than an area of a projection of the beam of light from the light source. The alignment device further includes a connector in connection with the body to place the alignment device in removable connection with the flame detector. In a number of embodiments, the light source is a laser.

The pattern of light may include at least one of: (i) a plurality of spaced areas of light, (ii) one or more extending areas of light, and (iii) one or more areas of light which are movable relative to the light source to sweep a projection of light though at least a portion of the field of view of the flame detector, for a determined distance from the flame detector.

The pattern of light may include at least one of a plurality spaced areas of light and one or more extending areas of light. In a number of embodiments, the pattern of light includes a plurality of spaced dots. In a number of embodiments, the pattern of light includes at least one of (i) a plurality of extending lines, and (ii) one or more closed curved shapes. The plurality of extending lines may intersect in the vicinity of the center of the field of view of the flame detector. The pattern of light may include one or more closed curved shapes. The pattern of light may include a plurality of close curved shapes which may be concentric, closed curved shapes. The concentric closed curved shapes may be circles or ellipses. The pattern of light may further include an indication of a center of the field of view.

In a number of embodiments, the one or more optical elements of the optics system include at least one optical element which is moveable relative to the light source to sweep the projection of light though the at least a portion of the field of view of the flame detector. The at least one optical element may be rotatable around a first axis. The first axis may coincide generally with an axis of the beam of light from the light source. The at least one optical element, which is movable, may, for example, include a mirror or a beam splitter. The one or more optical elements of the optics system may further include at least one optical element (for example, a diffractive optical element) configured to project a plurality of spaced areas of light.

The at least one optical element may be supported upon a holder which is attached to an adapter. The adapter is rotatable around the first axis. The holder is pivotably attached to the adapter to pivot about a second axis which is generally perpendicular to the first axis. Pivoting the holder controls an angle of reflectance of at least a first portion of the beam of light from the light source with respect to the axis of the beam of light from the light source.

In a number of embodiments, the at least one optical element includes a beam splitter which reflects the first portion of the beam of light from the light source at the angle and passes a second portion of the beam of light from the light source therethrough. The second portion of the beam of light from the light source may be oriented to project an approximate center of the field of view.

In a number of embodiments, the one or more optical elements of the optics system include at least one optical element selected from the group consisting of a lens, a mirror, a shutter, a beam splitter, a diffractor, a refractor, a parabolic reflector, an axicon, and a reflaxicon. In a number of embodiments, the one or more optical elements includes at least one other optical element configured to project a plurality of spaced areas of light (for example, a diffractive optical element).

A method of aligning a flame detector having a field of view includes removably attaching an alignment device to the flame detector. The alignment device includes a body and a visualization system including a light source positioned at a fixed position in the alignment device and an optics system including one or more optical elements which interact with a beam of light from the light source to project a pattern of light indicative of an area of the field of view of the flame detector for a determined distance from the flame detector. The projected pattern area or indicated area is larger than an area of a projection of the beam of light from the light source. The alignment device also includes a connector in connection with the body to removably attach the alignment device to the flame detector. The method further includes using the alignment device to project the pattern of light. In a number of embodiments, the light source comprises a laser.

In a number of embodiments, the pattern of light comprises at least one of: (i) a plurality of spaced areas of light, (ii) one or more extending areas of light, and (iii) one or more areas of light which are movable relative to the light source to sweep a projection of light though at least a portion of the field of view of the flame detector, for a determined distance from the flame detector. The plurality of extending lines may intersect in the vicinity of the center of the field of view of the flame detector. The pattern of light may include one or more closed curved shapes. The pattern of light may include a plurality of close curved shapes which may be concentric, closed curved shapes. The concentric closed curved shapes may be circles or ellipses. The pattern of light may further include an indication of a center of the field of view.

In a number of embodiments, the one or more optical elements of the optics system include at least one optical element which is moveable relative to the light source to sweep the projection of light though the at least a portion of the field of view of the flame detector. The at least one optical element may be rotatable around a first axis. The first axis may coincide generally with an axis of the beam of light from the light source. The at least one optical element, which is movable, may, for example, include a mirror or a beam splitter. The one or more optical elements may further include at least one other optical element (for example, a diffractive optical element) configured to project a plurality of spaced areas of light.

The at least one optical element, which is movable, may be supported upon a holder which is attached to an adapter. The adapter is rotatable around the first axis. The holder is pivotably attached to the adapter to pivot about a second axis which is generally perpendicular to the first axis. Pivoting the holder controls an angle of reflectance of at least a first portion of the beam of light from the light source with respect to the axis of the beam of light from the light source.

In a number of embodiments, the at least one optical element includes a beam splitter which reflects the first portion of the beam of light from the light source at the angle and passes a second portion of the beam of light from the light source therethrough. The second portion of the beam of light from the light source may be oriented to project an approximate center of the field of view.

In a number of embodiments, the one or more optical elements of the optics system include at least one optical element selected from the group consisting of a lens, a mirror, a shutter, a beam splitter, a diffractor, a refractor, a parabolic reflector, an axicon, and a reflaxicon. In a number of embodiments, the one or more optical elements include at least one optical element configured to project a plurality of spaced areas of light (for example, a diffractive optical element).

The present devices, systems, and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a side view of an embodiment of a flame detector including an embodiment of an alignment device hereof which is illustrated schematically and in broken lines as transparent.

FIG. 1B illustrates a front view of the flame detector alignment device of FIG. 1A wherein the alignment device is illustrated schematically and in broken lines as transparent.

FIG. 2A illustrates a horizonal FOV diagram and corresponding Table 1 for the flame detector of FIG. 1A for the fuel heptane.

FIG. 2B illustrates a vertical FOV diagram and corresponding Table 2 for the flame detector of FIG. 1A for the fuel heptane, wherein the grayed out portion is not visible when a rain guard is installed on the flame detector.

FIG. 3A illustrates a horizonal FOV diagram and corresponding Table 3 for the flame detector of FIG. 1A for the fuel methane.

FIG. 3B illustrates a vertical FOV diagram and corresponding Table 4 for the flame detector of FIG. 1A for the fuel methane, wherein the grayed out portion is not visible when a rain guard is installed on the flame detector.

FIG. 4A illustrates a sketch used to translate the two-dimensional (2D) horizontal profile of FIG. 3A into a three-dimensional (3D) model.

FIG. 4B illustrates a sketch used to translate the 2D vertical profile of FIG. 3B into a 3D model.

FIG. 5A illustrates a horizontal view of an approximate FOV cloud model created from the horizontal and vertical FOV sketches of FIGS. 4A and 4B.

FIG. 5B illustrates a vertical view of an approximate FOV cloud model created from the horizontal and vertical FOV sketches of FIGS. 4A and 4B.

FIG. 5C illustrates an isometric view of the approximate FOV cloud model.

FIG. 5D illustrates a rear view of the approximate FOV cloud model.

FIG. 6 illustrates a vertical view of the FOV cloud model at the flame detector of FIG. 1A.

FIG. 7A illustrates an embodiment projected laser pattern including generally centrally intersecting lines of an embodiment of an alignment device hereof with a 60 degree, half-angle cone extending to 50 feet (15.2 m) from the flame detector.

FIG. 7B illustrates an embodiment of a projected laser pattern including generally centrally intersecting lines with an elliptical profile extending 50 feet (15.2 m) from the detector and a matching FOV.

FIG. 8 illustrates an embodiment of a projected laser pattern including a circular profile (white dots) and an elliptical profile (dark dots) at 50 feet (15.2 m) from the detector.

FIG. 9A illustrates an embodiment of a projected laser pattern including concentric circles and a center dot.

FIG. 9B illustrates an embodiment of a projected laser pattern including concentric ellipses and a center dot.

FIG. 10A illustrates a side, partially cross-sectional view of another embodiment of flame detector alignment device hereof.

FIG. 10B illustrates a side view of the flame detector alignment device of FIG. 10A.

FIG. 10C illustrates a front isometric view of the flame detector alignment device of FIG. 10A.

FIG. 10D illustrates a front view of the flame detector alignment device of FIG. 10A.

FIG. 10E illustrates a rear isometric view of the flame detector alignment device of FIG. 10A.

FIG. 10F illustrates a projected laser pattern of flame detector alignment device of FIG. 10A.

FIG. 11A illustrates a side view of another embodiment of a flame detector alignment device hereof.

FIG. 11B illustrates a detail side view of encircled portion B of the flame detector alignment device of FIG. 11A.

FIG. 11C illustrates a front view of the flame detector alignment device of FIG. 11A.

FIG. 11D illustrates a side, partially cross-sectional view (section C-C, referring to FIG. 11C) of the flame detector alignment device of FIG. 11A.

FIG. 11E illustrates an isometric view of the flame detector alignment device of FIG. 11A.

FIG. 11F illustrates another isometric view of the flame detector alignment device of FIG. 11A.

FIG. 11G illustrates a projected light (for example, laser light) pattern of flame detector alignment device of FIG. 11A.

FIG. 12A illustrates a side view of another embodiment of a flame detector alignment device hereof.

FIG. 12B illustrates a detail side view of encircled portion D of the flame detector alignment device of FIG. 12A.

FIG. 12C illustrates a front view of the flame detector alignment device of FIG. 12A.

FIG. 12D illustrates a side, partially cross-sectional view (section E-E, referring to FIG. 12C) of the flame detector alignment device of FIG. 12A.

FIG. 12E illustrates an isometric view of the flame detector alignment device of FIG. 12A.

FIG. 12F illustrates another isometric view of the flame detector alignment device of FIG. 12A.

FIG. 12G illustrates a projected light (for example, laser light) pattern of flame detector alignment device of FIG. 12A.

FIG. 13A illustrates a side, partially cross-sectional view of another embodiment of a flame detector alignment device hereof.

FIG. 13B illustrates a detail side view of a portion of the flame detector alignment device of FIG. 13A.

FIG. 13C illustrates an isometric view of the flame detector alignment device of FIG. 13A.

FIG. 13D illustrates a projected light (for example, laser light) pattern of flame detector alignment device of FIG. 13A.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a light source” includes a plurality of such light sources and equivalents thereof known to those skilled in the art, and so forth, and reference to “the light source” is a reference to one or more such light sources and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

In a number of embodiments, alignment devices hereof provide a significant improvement in aligning or confirming where, for example, the center and/or the outer boundary of the FOV of a flame detector is/are located in an area to be monitored. In general, the light source (for example, a laser) used in devices, systems, and methods hereof remains stationary while an optical system in optical connection with the light source illuminates at least a portion of the FOV.

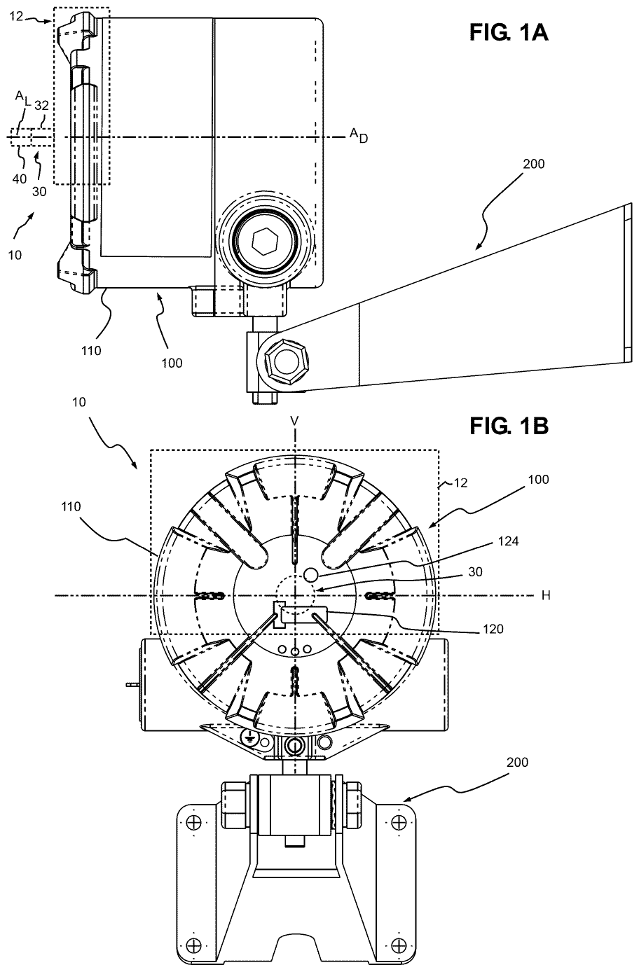

FIGS. 1A and 1B illustrate an embodiment of a device 10 hereof (illustrated schematically and in broken lines) in operative connection with a flame detector 100. In the illustrated embodiment, flame detector 100 is an FL500 flame detector (available from MSA Safety of Cranberry Township, Pennsylvania, USA). However, flame detectors alignment devices hereof, such as device 10, are readily modified or adapted for use with many flame detectors available from any number of manufacturers (including, for example, the FL5000 flame detector, available from MSA safety, etc.). The FL500 flame detector 100 is an ultraviolet/infrared (UV/IR) flame detector, which includes a housing 110, a UV radiation-sensitive phototube 120 and an IR detector 124 to sense specific wavelengths in the UV and IR spectral regions (see FIG. 1B). The UV and IR detectors 120, 124 send signals about changes in the intensity of UV and IR radiation to a microcomputer (not shown) within housing 110 to activate, for example, an alarm Low, an alarm High, and a fault output. Flame detector 100 is connected to a fixed structure via a connection frame 200.

As illustrated schematically in FIGS. 1A and 1B, alignment device 10 may be attached to a front, top, bottom, side, etc. of flame detector 100 via a connector 12 (illustrated schematically in FIGS. 1A and 1B). The attachment or connection of representative embodiments of device 10 to flame detector 100 via connector 12 is temporary or removable. In that regard, alignment device 10 may be attached to flame detector 100 only during detector orientation and alignment. Alignment device 10 will typically be removed after flame detector 100 is fixed into a determined orientation and alignment. As described above, alignment device 10 may be readily configured to fit multiple models/sizes of flame detectors. Embodiments of the device may be lightweight, and easily attachable to flame detector body or housing 110, for example, by clamping-on without the need for fixation devices (such as, bolts, screws, etc.). If fixation devices are used to lock alignment device 10 into a position, the tightening of such fixation devices desirably does not require use of hand tools such as screw-drivers, Allen-keys, etc.

In a number of embodiments, an FOV visualization system 30 hereof includes an optical pattern generator. In that regard, system 30 may include one or more optical/visible light sources 32 (for example, one or more lasers or laser pointers) and an optics system 40 including one or more optical component or elements which interact with one or more beams of light from one or more light sources 32 to generate a projected optical pattern indicative of at least a portion of the FOV of flame detector 100. In a number of embodiments, a single laser light source 32 is used. Laser light is, for example, readily collimated and provides advantages of economy and ease of manufacture. Green or red colored lasers may, for example, be used under various light conditions. Green lasers (having, for example, a wavelength around 532 nm) may be more visible that red lasers (typically having a wavelength in the range of 620-750 nm). In representative embodiments, the power output of a laser light source or pointer for user herein is preferably sufficient to illuminate an area on a physical surface at least 50 feet (15.2 meters) away from the detector.

Laser enhancement glasses, as known in the art, may be used in connection with alignment devices hereof to enhance visibility of projected patterns hereof and to extend visibly illuminated distances. Patterns formed from individual dots (or smaller areas of light) may be more readily visible than patterns formed with continuous lines. In that regard, light intensity may be greater for individual dots than for continuous, extending lines or other shapes. Each dot may thus be brighter than, for example, a continuous line. Further, one may use intermittent illumination or strobing to make the projected light more visible. In a number of embodiments, one or more dots or areas of light may be moved through at least a portion of the FOV via control of one or more optical components of an optical system hereof.

As illustrated in FIG. 1A, alignment device 10 may be connected to flame detector 100 so that an axis A_{L} of light source 32 is either aligned with the detector axis A_{P} or offset from that axis. In a number of embodiments, any offset is maintained relatively small or minimized. For example, A_{L} may be offset by a small distance such as approximately the radius/width of the detector enclosure for example, a housing and a secondary component such as a base or a lid) plus the radius/width of a laser holder (that is, a component of the alignment device that holds the laser). As described further below, optical component(s) of optics system 40 may be used to manipulate the incident beam of light from light source 32 to project a pattern which is indicative of the FOV of flame detector 100. In a number of embodiments, the pattern may be projected contemporaneously or simultaneously to be indicative of an area of the FOV which is larger than the projected area of the beam of light from light source 32. The projected pattern may include, for example, one or more lines, one or more curves, multiple points or dots, etc. The projected pattern may, for example, include an indication of the center of the FOV and an outer boundary thereof. Further indicia may be included to define the outer boundary of the FOV at multiple ranges (for example, one or more additional indicia may be projected within an outer boundary at one distance or range to indicate the smaller FOV at longer distance(s)).

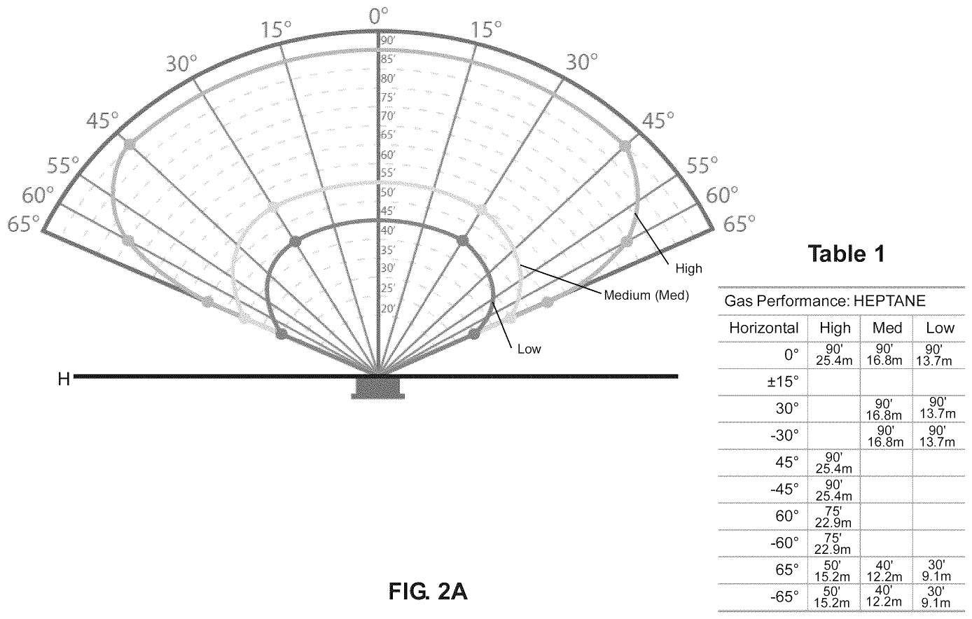

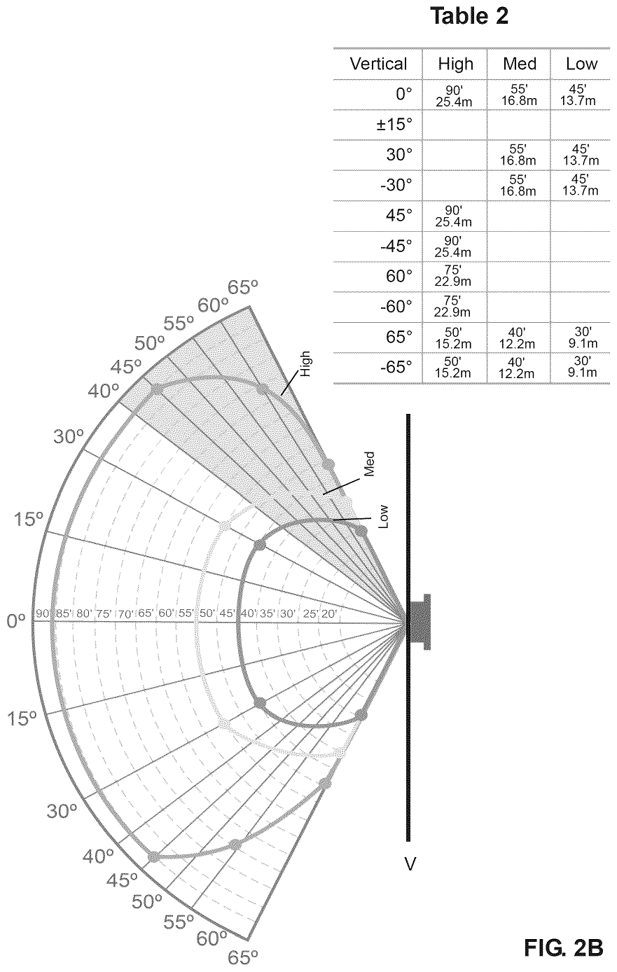

The FOV of a flame detector such as flame detector 100 varies depending upon a number of factors including, for example, the nature of the flame detector, the fuel, the sensitivity setting, use of any accessories that may partially block the FOV, the distance from the flame detector, etc. FIGS. 2A through 5D illustrate the FOV for the MSA FL500 flame detector over varying conditions. FIGS. 2A and 2B (including the graphical portion and Tables 1 and 2 thereof) illustrate the horizontal and vertical FOV, respectively, along the horizontal plane H and the vertical plane V (see FIG. 1B) as a function of distance (in feet and meters) for various sensitivity settings (High, Medium (Med), and Low) and for the fuel heptane. FIGS. 2A and 2B illustrate the dependence of FOV on plane, sensitivity setting, and distance or range from flame detector 100. FIG. 2B also illustrates the effect of using a rain guard accessory (part no. 10236202, available from MSA Safety) in connection with flame detector 100. In that regard, the shaded portion of the graph of FIG. 2B will not be visible when a rain guard accessory (not illustrated in the figures) is installed in connection with flame detector 100.

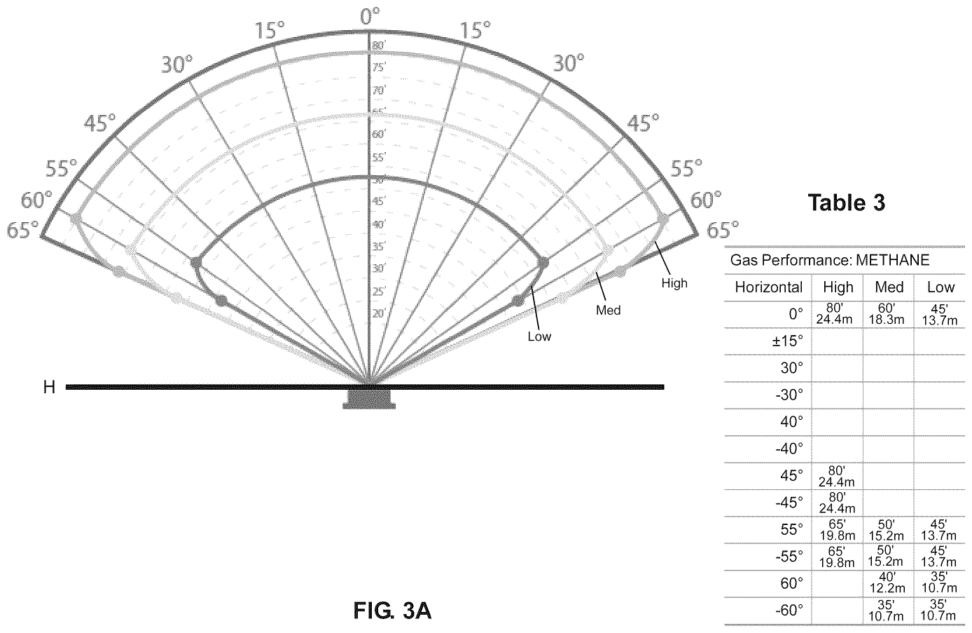

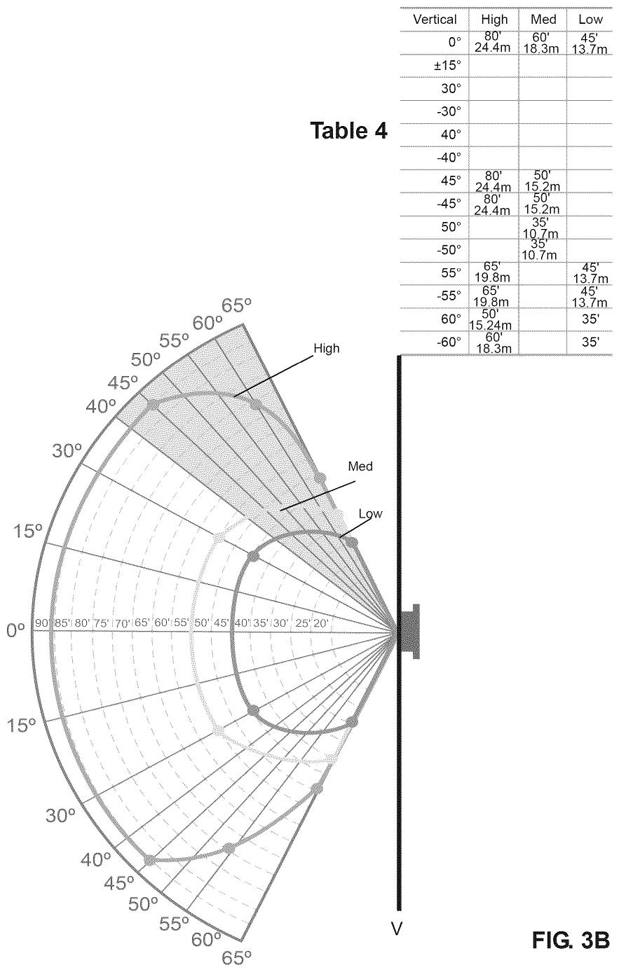

FIGS. 3A and 3B (including the graphical portion and Tables 3 and 4 thereof) illustrate the horizontal and vertical FOV, respectively, along the horizontal plane H and the vertical plane V as a function of distance or range (in feet and meters) for various sensitivity settings (High, Medium (Med), and Low) and for the fuel methane. Similar to FIGS. 2A and 2B, FIGS. 3A and 3B illustrate the dependence of FOV on plane, sensitivity setting, and distance from flame detector 100. FIG. 3B also illustrates the effect of using a rain guard accessory in connection with flame detector 100. Similar to FIG. 2B, the shaded portion of the graph of FIG. 3B will not be visible when a rain guard accessory is installed in connection with flame detector 100. A comparison of the planar views of FOV illustrated in FIGS. 2A and 2B with the those illustrated in FIGS. 3A and 3B demonstrate the dependence of FOV on fuel (heptane and methane in the illustrated embodiments).

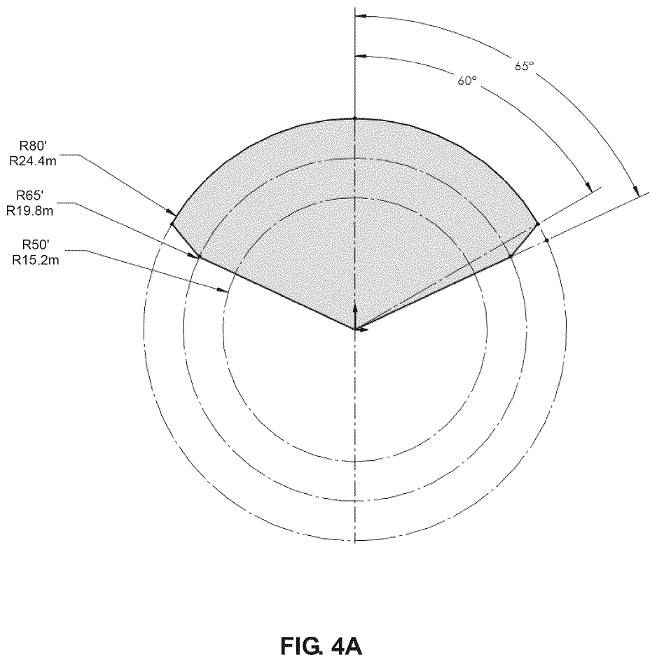

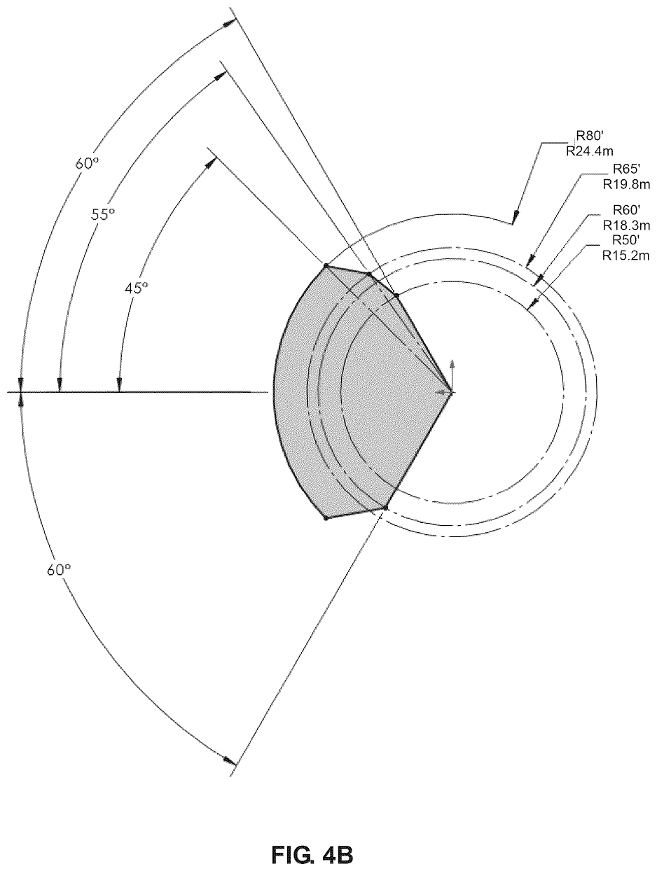

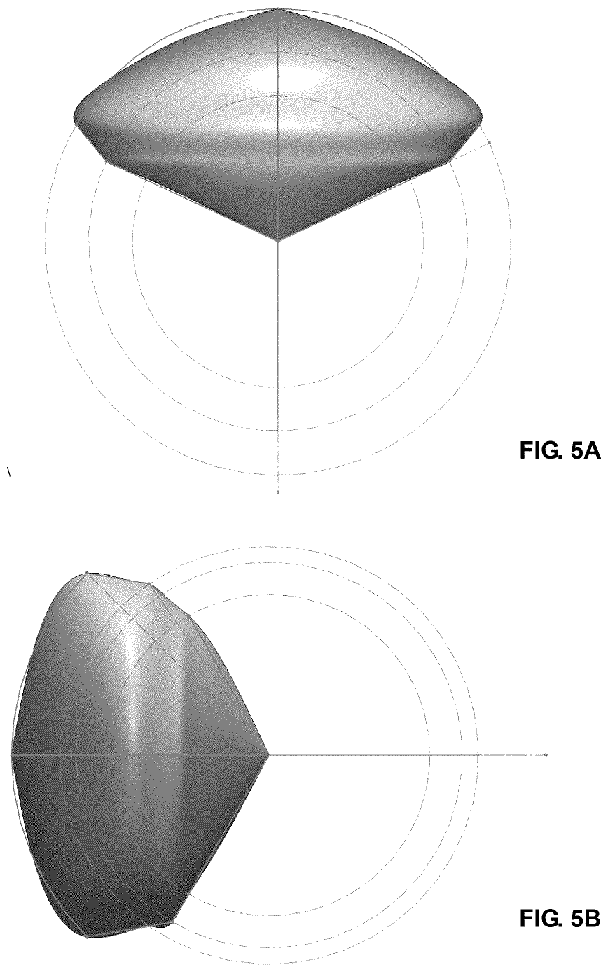

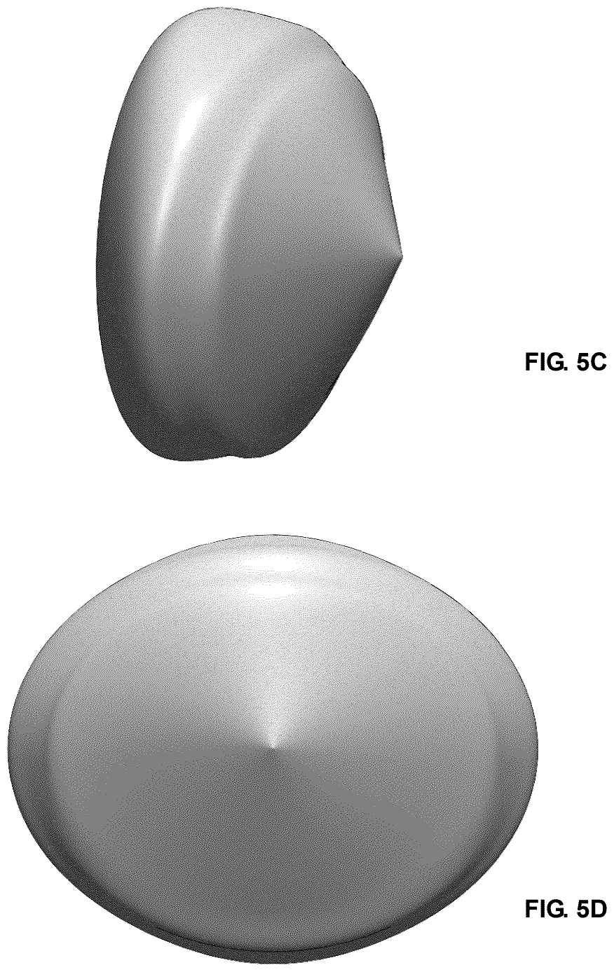

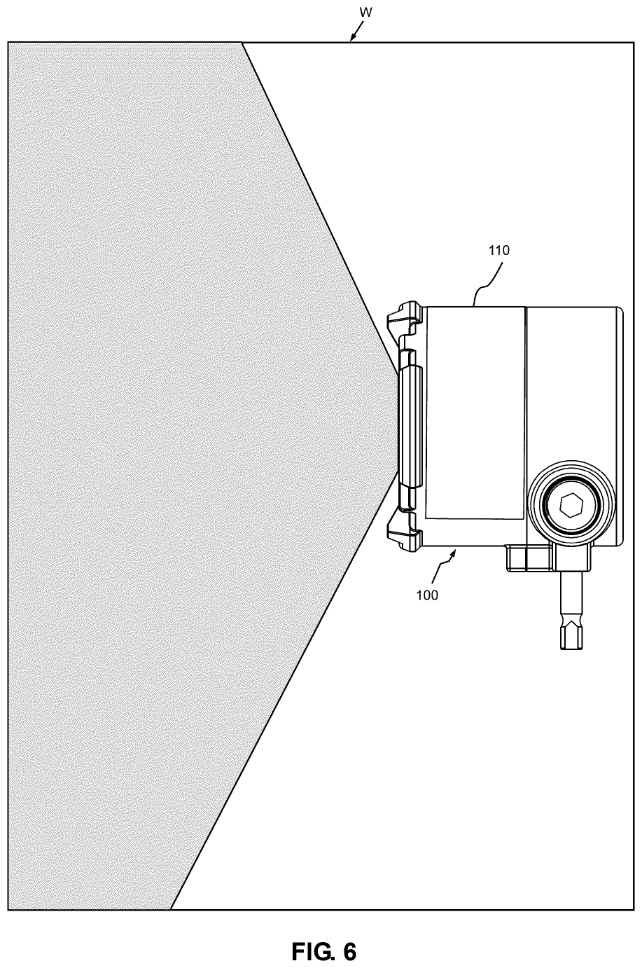

FIG. 4A illustrates an embodiment of a sketch used to translate the two-dimensional (2D) horizontal profile of FIG. 3A (methane) into a three-dimensional (3D) model. FIG. 4B illustrates a sketch used to translate the 2D vertical profile of FIG. 3B into a 3D model. FIG. 5A illustrates a horizontal view of an approximate FOV cloud model created from the horizontal and vertical FOV sketches of FIGS. 4A and 4B. FIG. 5B illustrates a vertical view of the approximate FOV cloud model created from the horizontal and vertical FOV sketches of FIGS. 4A and 4B. An isometric view and a rear view of the approximate FOV cloud model is illustrated in FIGS. 5C and 5D, respectively. FIG. 6 illustrates a vertical view of a portion (within a rectangular view window W) of the FOV cloud model at flame detector 100. In developing the approximate FOV cloud models, the horizontal and vertical FOV sketches were used as references in CAD design software (SOLIDWORKS, available from Dassault Systèmes of Vélizy-villacoublay, France) to create ellipse profiles at several distances from the detector. Each ellipse is an approximation of the FOV between the H and V planes. The set of ellipses were then used to create a loft or forward projection feature to give a 3D representation of the FOV. The transitions between the ellipses in the loft feature are also approximations.

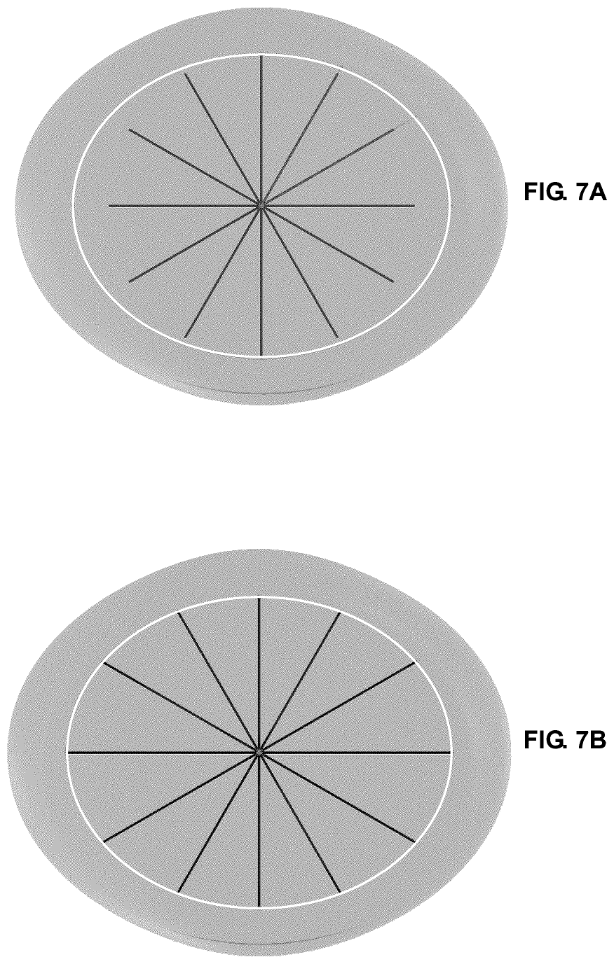

FIG. 7A illustrates a representation of the rear view of the cloud model as set forth in FIG. 5D for points at a range of 50 feet (15.2 m) and beyond. FIG. 7A also illustrates an embodiment projected laser pattern (that would be projected on a surface 50 feet (15.2 m) from flame detector 100). The laser pattern is formed from generally centrally intersecting lines by an embodiment of an alignment device 10 hereof with a 60 degree half cone angle. FIG. 7B illustrates an embodiment of a projected laser pattern including generally centrally intersecting lines with an elliptical profile (that would be projected on a surface 50 feet (15.2 m) from flame detector 100) overlain on the rear view of the cloud model of FIG. 7A. As seen in a comparison of FIG. 7B and FIG. 7A, the generally elliptical pattern of FIG. 7B is more representative of the actual FOV at 50 feet (15.2 m), represented by a white ellipse in each of FIGS. 7A and 7B, for the specific detector, flame type/fuel, sensitivity setting, and range. The projected optical pattern of FIG. 7B (including centrally intersecting, extending lines) provides a nearly exact match for the FOV at 50 feet (15.2 m). Further optimization of optics of the pattern generation system hereof using engineering principles may be used to provide further improvement in the indication of FOV at various ranges using laser alignment devices hereof.

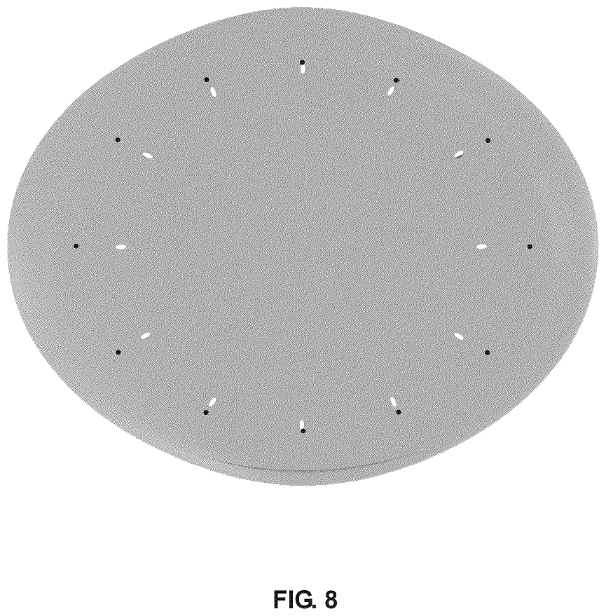

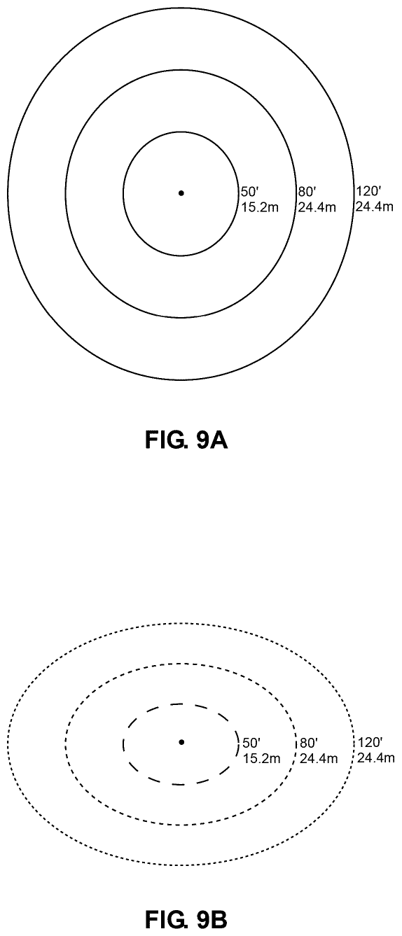

FIG. 8 illustrates an embodiment of a projected laser pattern including a circular profile (white dots) and an elliptical profile (dark dots) at 50 feet (15.2 m) from the detector. A representative projection of a concentric circle pattern including a center dot is provided in FIG. 9A. A representative projection of a concentric elliptical pattern, wherein the ellipses are formed from a plurality of spaced projected areas/dots and including a projected center area/dot is provided in FIG. 9B. An indicator of the center of the FOV is desirable in many circumstances.

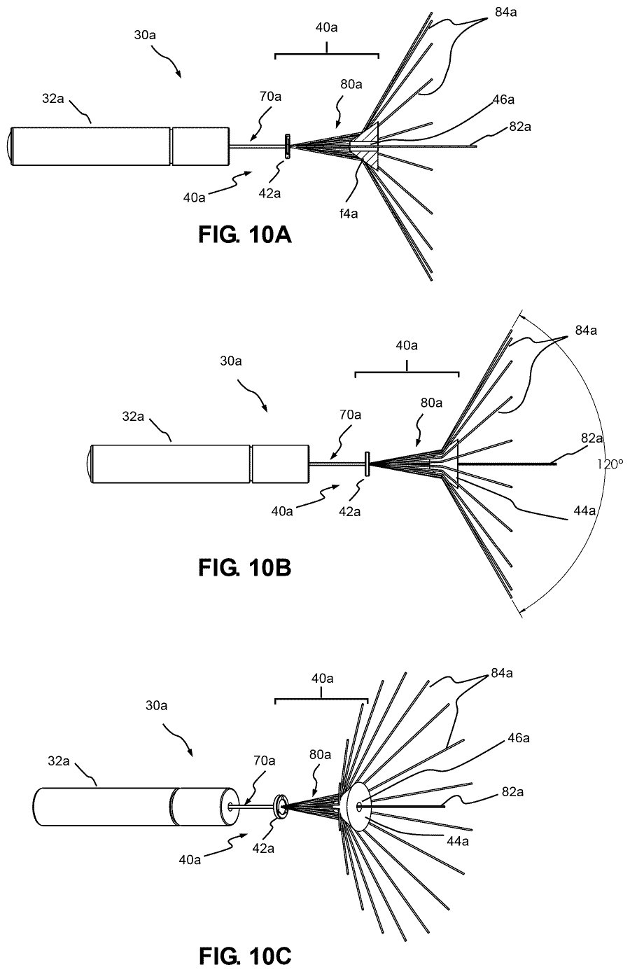

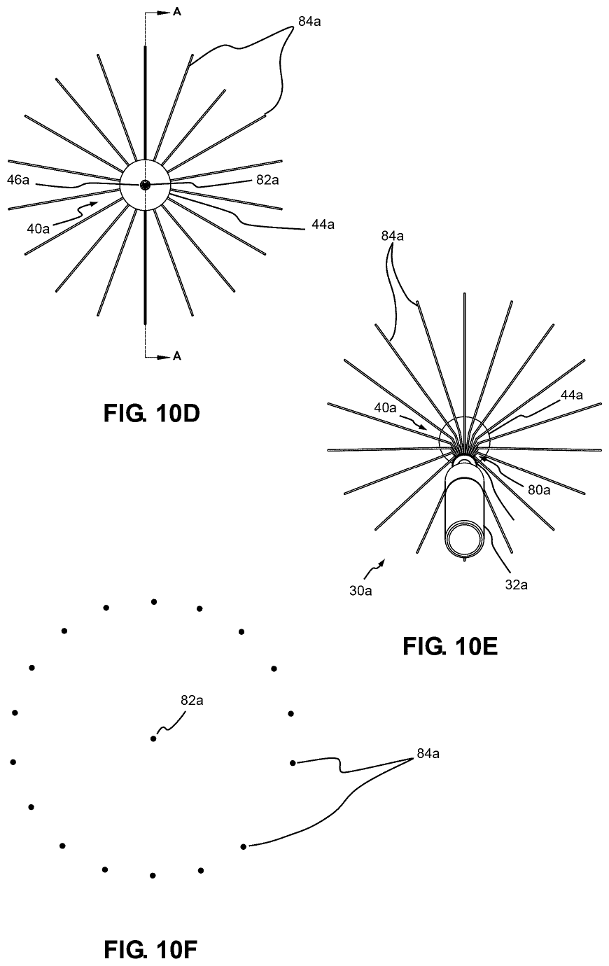

FIGS. 10A through 10E illustrate another embodiment of an FOV visualization system 30a hereof. System 30a includes a light source 32a such as a standard alignment laser (for example, the Galileo Pro alignment laser (532 nm-green) available from LaserGlow Technologies of North Your, ON Canada) which emits a beam of light 70a. System 30a further includes an optics system 40a in optical connection with light source 32a which include one or more optical component or elements. In the illustrated embodiment, optic system 40a includes a diffractive optical element (DOE) 42a which is placed in optical connection with light source 32a to split incident laser beam 70a into a circular pattern of beams 80a (which project dots when impinging upon a surface) including a center beam/dot 82a and a generally circular pattern of reflected beams/dots 84a. An example of a suitable DOE 42a is part number FDE-R221 (1:72 dot circle) available from Frankfurt Laser Company of Friedrichsdorf, Germany. Optics system 40a further includes a cone mirror 44a to increase the angle of the circular pattern of reflected beams/dots 84a to match a common field of view (FOV) (for flame detectors as described above) having various diameters such as 90 degrees or 120 degrees. Cone mirror 44a includes a passage 46a therethrough to allow center beam 82a from DOE 42a to pass therethrough and to identify or indicate the approximate center of the FOV of the flame detector. When mounted on a flame detector such as flame detector 100, device 10a simultaneously projects a circular pattern of dots corresponding to a specific FOV angle and a center dot representing the center of the FOV as illustrated in FIG. 10F.

In a number of embodiments, an optical system or pattern generator system hereof may also use one or more shutters or similar devices as optical components to assist in creating a pattern indicative of at least a portion of an FOV. For example, an optical system may generate a plurality of centrally intersecting lines which extend beyond the boundaries of all potential FOVs of a flame detector system with which the optical system may be used. A variable shutter system (for example, including a plurality of different shutter openings) may be used to adjust the pattern to a particular FOV,

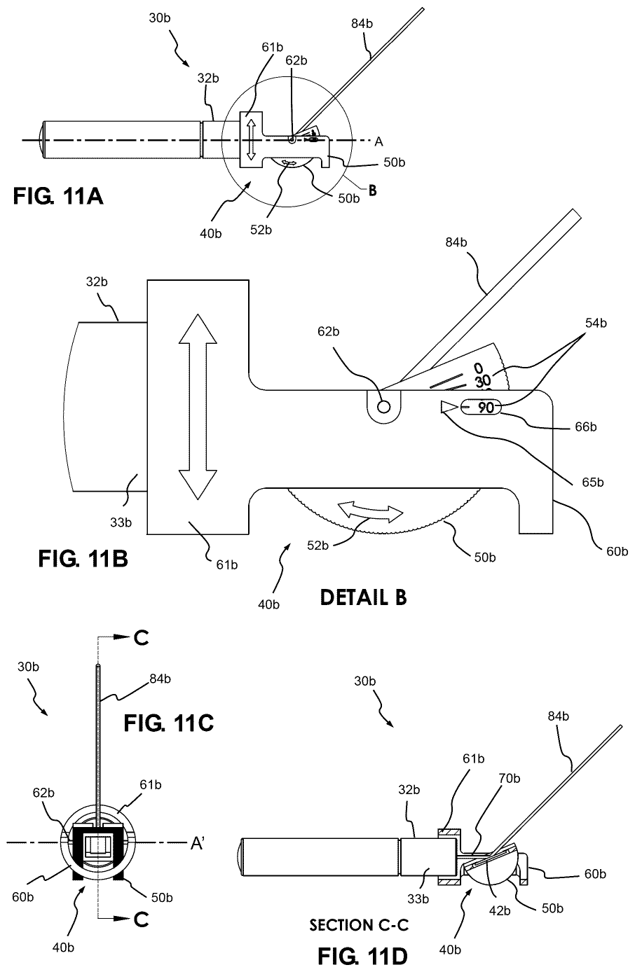

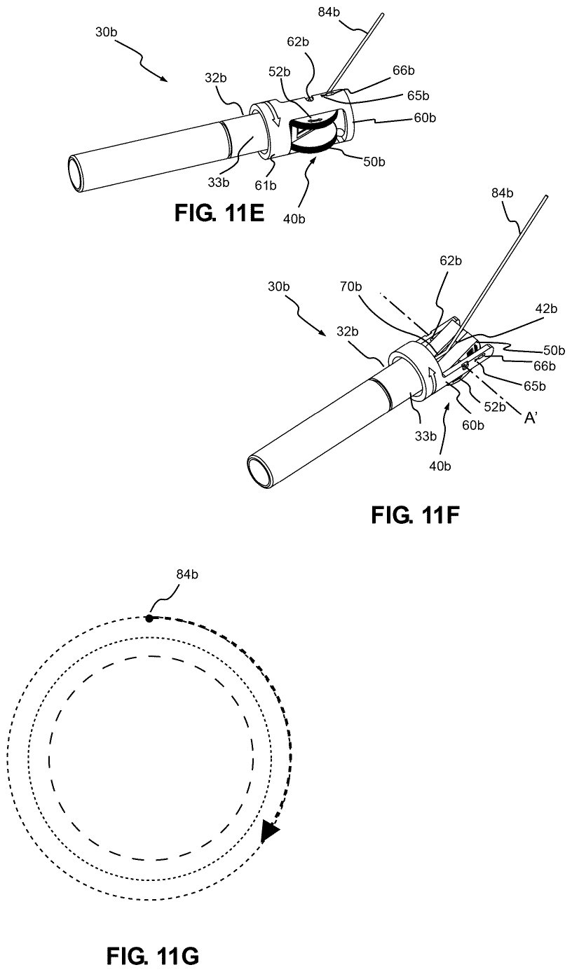

FIGS. 11A through 11G illustrate another embodiment of a system 30b hereof in which an optics system 40b is used to move or scan a dot or other area of light through an area indicative of at least a portion of the area of an FOV. System 30b includes a light source 32b such as a standard alignment laser (for example, the Galileo Pro alignment laser (532 nm-green) available from LaserGlow Technologies) which emits a beam of light 70b. In the illustrated embodiment, optics system 40b includes an optical element in the form of a mirror 42b (see, for example, FIGS. 11D and 11F), which may be a flat mirror, and mechanical components which interact with the optical element. In that regard, mirror 42b is positioned within a holder or carriage 50b. In the illustrated embodiment, holder 50b is connected to light source 32b via an adapter 60b which pivots or rotates on or around a housing 33b of laser light source 32b via, for example, a bearing or sleeve bearing (not shown) which cooperates with a rearward section 61b of adapter 60b. Referring, for example, to FIGS. 11B, 11C and 11F, holder 50b is attached to adapter 60b via a rod 62b defining an axis A′ (which may be generally perpendicular to axis A of laser 30b and adapter 60b) about which holder 50b can be pivoted/rotated as represented by arrow 52b. When mounted on a flame detector such as flame detector 100, system 30b projects a single beam/dot 84b corresponding to a point in the FOV. The projection angle for beam/dot 84b (and thus the diameter of the path of beam/dot 84b upon rotation of adapter 40b) can be set by aligning an arrow 65b on adapter 60b with one of several markings 54b (which may, for example, correspond to angles) on mirror holder 50b, wherein a selected one of alignment markers 54b is visible through a passage or window 66b in adapter 60b. The perimeter of the FOV or circles at various positions within the FOV (as determined by the rotational position of holder 50b about axis A′) can, for example, be swept out by rotating adapter 60b on laser housing 33b as illustrated in FIG. 11G. Several concentric paths (concentric circles in broken lines) for beam/dot 84b are illustrated in FIG. 11G representing several different angle settings for holder 50b. Since a laser dot moving over different surfaces and structures on the perimeter of or within the FOV may be more visible to a user, adapter 60b may readily be made to rotate easily and quickly using, for example, a sleeve bearing or a trigger mechanism to connect to laser housing 33b. A trigger mechanism may, for example, include a lever, which may include associated gearing, which causes rotation of adapter 60b by a certain number of degrees. Holder 50b may be pivoted during rotation of adapter 60b to, for example, create an elliptical or other path of beam 84b. Gearing, as known in the mechanical, art may, for example, be used in connection with pivoting of holder 50b during rotation of adapter 60b to create a desired path of beam 84b. The motion of one or both of adapter 60b may be powered using, for example, one or more electric motors.

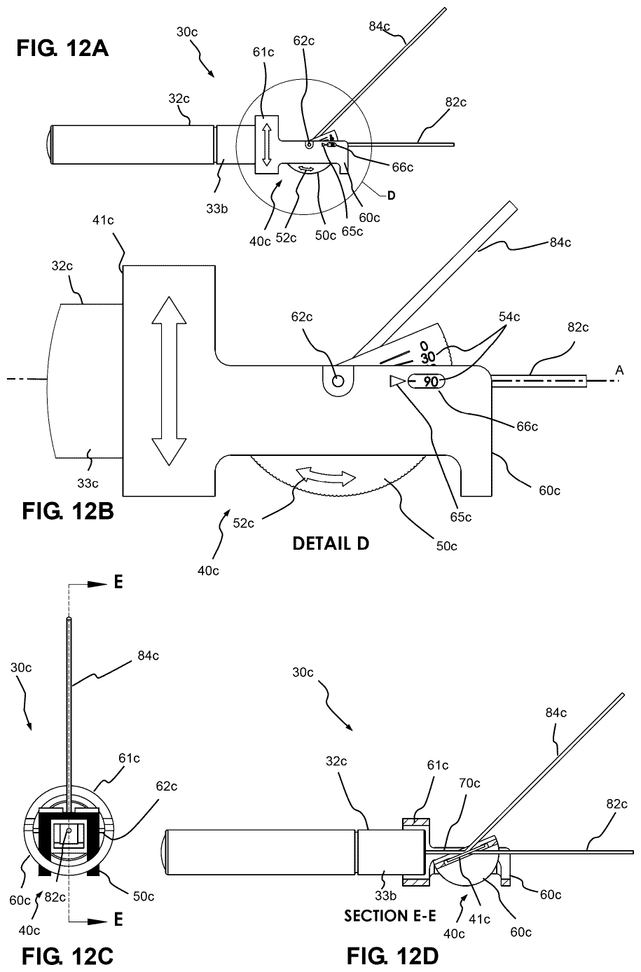

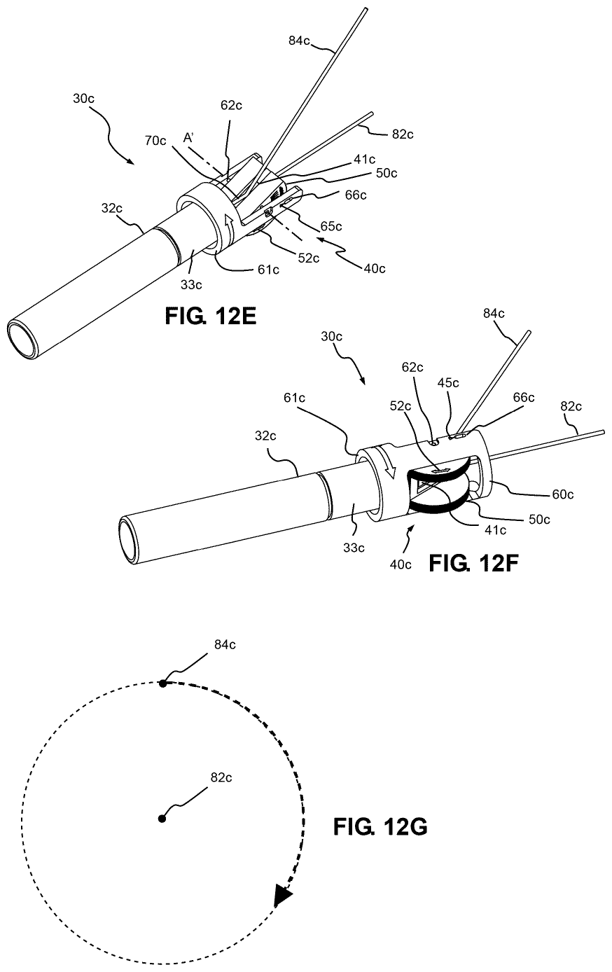

FIGS. 12A through 12G illustrate another embodiment of a system 30c hereof which operates in a manner similar to system 30b. Elements in system 30c are numbered similarly to like elements in system 30b, wherein the designation “b” following the numeral is replaced with the designation “c” in the case of elements of system 30c. Similar to system 30b, system 30c includes a light source 32c such as a standard alignment laser which emits a beam of light 70c. System 30c further includes an optics system 40c including optical elements or components, which include a beam splitter 41c, as wells as mechanical components which interact with the optical components. As known in the optical arts, beam splitter 41c reflects a portion of incident light beam 70c and transmits a portion of incident light beam 70c. Beam splitter 41c is positioned with a holder or carriage 50c, which operates similarly to holder 50b. In that regard, holder 50c is connected to light source 32c via adapter 60c which rotates on a housing 33c of laser light source 32c. Holder 50c is attached to adapter 60c via rod 62c defining axis A′ (which may be generally perpendicular to axis A of laser 32c and adapter 60c) about which holder 50c can be pivoted/rotated as represented by arrow 52c. Beam splitter 41c splits incident beam 70c into a center beam/dot 82c and an angled (with respect to incident beam 70c) or perimeter beam/dot 84c.

When mounted on a flame detector such as flame detector 100, system 30c projects beam/dot 84c corresponding to a point in or indicative of a diameter of the FOV (or a point within that diameter). The projection angle for beam/dot 84c (and thereby the swept diameter) can be set by aligning an arrow 65c on adapter 60c with one of several markings 54c on the mirror holder 50c, wherein the aligned marker is visible through a passage or window 66c in adapter 60c. The perimeter of the FOV or circles at various angles within the FOV (as determined by the rotational position of holder 50c about axis A′) can, for example, be swept out by rotating adapter 60c on laser housing 33c as illustrated in FIG. 11G. Since a laser dot moving over different surfaces and structures on the perimeter of or within the FOV may be more visible to a user, adapter 60c may readily be made to rotate easily and quickly using, for example, a sleeve bearing or a trigger mechanism to connect to laser housing 53c as described above. As illustrated in FIG. 12G, center beam/dot 82c is projected contemporaneously or simultaneously with swept dot 84c. The alignment or orientation of center beam/dot 82c may be coaxial or approximately coaxial with axis A so that center beam/dot 82c does not move or moves very little with rotation of adapter 40c.

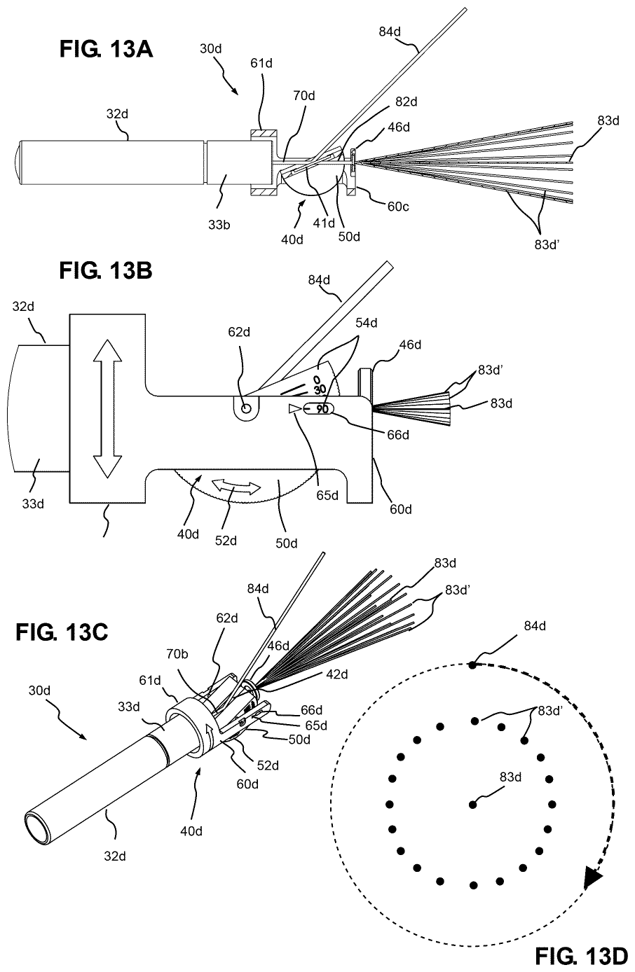

FIGS. 13A through 13D illustrate another embodiment of a system 30d hereof which operates in a manner similar to system 30c. Elements in system 30d are numbered similarly to like elements in system 30c, wherein the designation “c” following the numeral is replaced with the designation “d” in connection with the elements of system 30d. Similar to system 30c, system 30d includes a light source 32d such as a standard alignment laser which emits a beam of light 70d (see FIG. 13A). System 30d further includes an optics system 40d including optical elements or components, which include a beam splitter 41d, as well as mechanical components which interact with the optical components. Beam splitter 41d reflects a portion of incident light beam 70d and transmits a portion of incident light beam 70d. Beam splitter 41d is positioned with a holder or carriage 50d, which operates similarly to holder 50c. In that regard, holder 50d is connected to light source 32d via adapter 60d which rotates on a housing 33d of laser light source 32d. Holder 50d is attached to adapter 60d via rod 62d about which holder 50d can be pivoted/rotated as represented by arrow 52d in FIG. 13B. Beam splitter 41d splits incident beam 70d into a center beam 82d and an angled or perimeter beam/dot 84d (see, for example, FIG. 13A).

Unlike system 30c, system 30d further includes a diffractive optical element or DOE 46d connected to adapter 60d in the optical path of center beam 82b. In the illustrated embodiment, DOE 46d project a pattern within the FOV where potential flame sources or critical assets might be located. As, for example, illustrated in FIGS. 13C and 13D, the pattern projected by DOE 46d includes a center beam/dot 83d and peripheral beams/dots 83d′, which form a circle. Many different patterns are possible using DOEs, however, as described above. Beam/dot 84d may follow the a closed curved path such as a circle or an ellipsis (see, FIG. 13D).

An alignment device hereof may, for example, be part of an alignment system or kit which includes a plurality of optical components to project the FOVs for different flame detectors. For each such flame detector, additional optical elements could be used to project the FOV for different fuel types and sensitivity settings.

A number of advantages are provided by alignment devices 10 hereof compared to existing laser alignment devices. For example, in a number of embodiments, a significant portion of or approximately the entire area of the FOV may be shown or indicated at one time (that is, contemporaneously or simultaneously), and in one or multiple planes. Further, the outer boundary may be more closely approximated to a detector's actual FOV using various optical components as described herein. In that regard, the horizontal and vertical FOVs of a detector are usually not identical to each other or necessarily symmetric so rotating a laser in a holder through 360 degrees (to trace a circular boundary with individual areas of light generated sequentially in time) may lead a user to believe that the detector's area of coverage is greater than it actually is. Moreover, in embodiments in which one or more areas of light or dots are moved or scanned through an area to indicated at least a portion of an FOV, maintaining a stationary light source and using the optics system to move scan the one or more areas of light or dots provides significant advantages including, but not limited to, facilitating quick and efficient movement of the one or more areas of light or dots, the provision of more than one area of light or dot (including a centrally positioned area of light or dot), increased stability, increased durability, increased control of the path of movement, and increased variability in the path of movement.

Many different patterns of light may be projected in the devices, systems, and methods hereof. The user may adjust the detector based on the FOV diagrams in the instruction manual for the detector, fuel, and sensitivity setting to be used. A plurality of patterns overlaid or superimposed patterns may be projected. In a number of embodiments, one may project two or more spaced areas of light (for example, lines or concentric circles which may, for example, correspond to cones with 45 degree and 60 degree half angles). A concentric circle pattern with a center dot may, for example, be formed using the DE-R 259 diffractive optical element available from HOLOEYE Photonics AG of Berlin, Germany. In general, DOEs can project virtually any 2D shape (such as those illustrated in, for example, FIGS. 7A through 9B).

Many different, optical elements can be used in the pattern generation systems hereof, including, for example, various lenses, mirrors, shutters, diffractors, refractors, parabolic reflectors, axicons, reflaxicons etc., as known in the optical arts. For example, a Powell lens or a Diffractive Optical Element (DOE) may be used to split the incident laser beam into, for example, multiple spaced points, one or more lines, a closed curved shape such as a circle or an ellipse, concentric circles or ellipses, etc. As known in the art, ellipses and circles are closed curved shapes. An ellipse is defined as the set of all points in a plane wherein the sum of the distances to two fixed points, called foci, is constant. A circle is a special form of an ellipse wherein both of the foci are positioned at the center of the circle.

DOEs are optical components that deflect light into multiple orders at defined angles. DOEs are relatively inexpensive and can, for example, be used to project multiple points or shapes using a single laser. Variously shaped reflective optical components such as cone mirrors of different half angles may be used to project circles and other shapes. Cone mirrors may include a central passage to project an indication of a center point. Flat mirrors may also be used. Various combinations of optical elements may be used as known in the optical arts.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. An alignment device for use with a flame detector having a field of view, comprising:
a body,
a visualization system in connection with the body comprising
a light source positioned at a fixed position relative to the body; and
an optics system comprising one or more optical components which interact with a beam of light from the light source to project a pattern of light indicative of an area of the field of view of the flame detector for a determined distance from the flame detector, the indicated area of the field of view being larger than an area of a projection of the beam of light from the light source, and
a connector in connection with the body to place the alignment device in removable connection with the flame detector.

2. The alignment device of claim 1 wherein the pattern of light comprises at least one of: (i) a plurality of spaced areas of light, (ii) one or more extending areas of light, and (iii) one or more areas of light which are movable relative to the light source to sweep a projection of light though at least a portion of the field of view of the flame detector, for a determined distance from the flame detector.

3. The alignment device of claim 2 wherein the light source comprises a laser.

4. The alignment device of 3 wherein the pattern of light comprises at least one of a plurality spaced areas of light and one or more extending areas of light.

5. The alignment device of claim 3 wherein the pattern of light comprises a plurality of spaced dots.

6. The alignment device of claim 3 wherein the pattern of light comprises at least one of (i) a plurality of extending lines, and (ii) one or more closed curved shapes.

7. The alignment device of claim 6 wherein the plurality of extending lines intersects in the vicinity of the center of the field of view of the flame detector.

8. The alignment device of claim 3 wherein the pattern of light comprises one or more closed curved shapes.

9. The alignment device of claim 8 comprising concentric, closed curved shapes.

10. The alignment device of claim 8 wherein the closed curved shapes are circles or ellipses.

11. The alignment device of claim 8 wherein the pattern of light further comprises an indication of a center of the field of view.

12. The alignment device of claim 3 wherein the one or more optical components comprise at least one optical element which is moveable relative to the light source to sweep the projection of light though the at least a portion of the field of view of the flame detector.

13. The alignment device of claim 12 wherein the at least one optical element is rotatable around a first axis.

14. The alignment device of claim 13 wherein the first axis coincides generally with an axis of the beam of light from the light source.

15. The alignment device of claim 14 wherein the at least one optical element comprises a mirror or a beam splitter.

16. The alignment device of claim 15 wherein the at least one optical element is supported upon a holder which is attached to an adapter, the adapter being rotatable around the first axis, the holder being pivotably attached to the adapter to pivot about a second axis which is generally perpendicular to the first axis, wherein pivoting the holder controls an angle of reflectance of at least a first portion of the beam of light from the light source with respect to the axis of the beam of light from the light source.

17. The alignment device of claim 16 wherein the at least one optical element comprises a beam splitter which reflects the at least a first portion of the beam of light from the light source at the angle and passes a second portion of the beam of light from the light source therethrough, the second portion of the beam of light from the light source being oriented to project an approximate center of the field of view.

18. The alignment device of claim 12 wherein the one or more optical components further comprise at least one other optical element configured to project a plurality of spaced areas of light.

19. The alignment device of claim 2 wherein the one or more optical components comprise at least one optical element selected from the group consisting of a lens, a mirror, a shutter, a beam splitter, a diffractor, a refractor, a parabolic reflector, an axicon, and a reflaxicon.

20. The alignment device of claim 2 wherein the one or more optical components comprise at least one optical element configured to project a plurality of spaced areas of light.

21. The alignment device of claim 20 wherein the at least one optical element is a diffractive optical element.

22. A method of aligning a flame detector having a field of view, comprising:
removably attaching an alignment device to the flame detector, the alignment device comprising
a body,
a visualization system comprising
a light source positioned at a fixed position in the alignment device;
an optics system comprising one or more optical components which interact with a beam of light from the light source to project a pattern of light indicative of an area of the field of view of the flame detector for a determined distance from the flame detector, the indicated area being larger than an area of a projection of the beam of light from the light source; and
a connector in connection with the body to removably attach the alignment device to the flame detector; and
using the alignment device to project the pattern of light.

23. The method of claim 22 wherein the pattern of light comprises at least one of: (i) a plurality of spaced areas of light, (ii) one or more extending areas of light, and (iii) one or more areas of light which are movable relative to the light source to sweep a projection of light though at least a portion of the field of view of the flame detector, for a determined distance from the flame detector

24. The method of claim 23 wherein the light source comprises a laser.
